(19) United States
(12) Patent Application Publication
(10) Pub. No.: US 2019/0090281 A1
(43) Pub. Date: Mar. 21, 2019

(54) METHOD AND APPARATUS FOR SUPPORTING SUB-CHANNEL PHYSICAL RESOURCE BLOCK UPLINK TRANSMISSION IN A WIRELESS COMMUNICATION SYSTEM

(71) Applicant: SIERRA WIRELESS, INC., Richmond (CA)

(72) Inventor: Gustav Gerald VOS, Surrey (CA)

(21) Appl. No.: 16/138,298

(22) Filed: Sep. 21, 2018

Related U.S. Application Data
(60) Provisional application No. 62/561,330, filed on Sep. 21, 2017.

(51) Int. Cl. H04W 74/08; H04W 72/04

(52) U.S. Cl. CPC H04W 74/0833; H04W 72/04

(57) ABSTRACT

Methods and apparatuses for supporting sub-channel physical resource block uplink transmission in a wireless communication system are provided. In accordance with aspects, there is provided a method for performing sub-channel physical resource block (PRB) uplink transmission by a user equipment (UE) of a wireless communication network. The method includes generating plural sub-PRB transmissions for provision of a RACH procedure message 3 (msg3) and transmitting the plural sub-PRB transmissions. In accordance with aspects, there is provided a method in a base station of a wireless communication network, for supporting sub-channel PRB uplink transmission by a UE. The method includes receiving plural sub-PRB transmissions and combining the plural sub-PRB transmissions to determine RACH procedure msg3.

### CROSS REFERENCE TO RELATED APPLICATIONS

This application claims the benefit of priority to U.S. Provisional Patent Application No. 62/561,330 entitled “Method and Apparatus for Supporting Sub-Channel Physical Resource Block Uplink Transmission in a Wireless Communication Network” filed Sep. 21, 2017, the contents of which are incorporated herein by reference in their entirety.

### FIELD OF THE INVENTION

The present invention pertains in general to wireless communications, for example following the long term evolution (LTE) standard, and in particular to a method and apparatus for supporting sub-channel physical resource block uplink transmission in a wireless communication system.

### BACKGROUND

FIG. 1 illustrates a messaging sequence between the terminal (e.g. user equipment, UE) and base station (e.g. evolved NodeB, eNB) according to the prior art LTE standard. A relevant part of FIG. 1 includes the UE transmitting a physical random access channel (PRACH) preamble (Msg1), the eNB responding by transmitting a physical downlink shared channel (PDSCH) random access response indicating an uplink resource allocation, and the UE transmitting a physical uplink shared channel (PUSCH) radio resource control (RRC) connection resume request (Msg3 105) using the uplink resource allocation.

It is known that sub-channel physical resource block (PRB) uplink transmission will be an optional UE capability. However, UE capabilities are normally exchanged late in the random access channel (RACH) procedures. As such, sub-channel PRB capabilities would not be available for a substantial portion of RACH procedures. In the case of UEs that are sending small data traffic transmissions, the requirement of performing complete RACH procedures requires a significant amount of the transmission and can be a contributor to the total power consumption by the UE. As is known, for UEs including machine type communication (MTC) devices and Internet of things (IoT) devices, the conservation of power is of great importance.

In order to attempt to overcome this issue, PRACH partitioning has been suggested. For example, the UE would pick a PRACH index from a specific range of PRACH indexes which would indicate to the eNB that the UE supports sub-channel PRB transmission. However, a problem with this configuration is that PRACH partitioning reduces capacity as there is limited PRACH space and the size of each partition needs to be managed to avoid increasing the number of collisions.

As another attempt to overcome this issue, it has been suggested that the UE indicates that it supports sub-channel PRB in Msg3 105. However, a problem with this configuration is that Msg3 currently has no available bits for this indication. There is the possibility of increasing the bit allocation of Msg3 however this revised Msg3 configuration would need to be provided to all UEs (e.g. including smart phones) and as such this revised Msg3 configuration would waste communication system capacity.

Therefore there is a need for a method and apparatus for supporting sub-channel physical resource block (PRB) uplink transmission in a wireless communication system, such as an LTE system, that is not subject to one or more limitations of the prior art.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a method and apparatus for supporting sub-channel PRB uplink transmission in a wireless communication system, such as an LTE system. In accordance with aspects of the present invention, there is provided a method for performing sub-channel PRB uplink transmission by a UE of a wireless communication network. The method includes generating plural sub-channel PRB transmissions for provision of a RACH procedure message 3 (msg3) and transmitting the plural sub-channel PRB transmissions.

In some embodiments, the method further includes receiving sub-channel PRB allocations for subsequent transmissions. In some embodiments, the method further includes receiving a broadcast indicating sub-channel PRB transmissions are supported by a base station.

In accordance with another aspect of the present invention, there is provided a method, in a base station of a wireless communication network, for supporting sub-channel PRB uplink transmission by a UE. The method includes receiving plural sub-channel PRB transmissions and combining the plural sub-channel PRB transmissions to determine RACH procedure msg3.

In some embodiments, the method further includes transmitting allocations for subsequent transmissions. In some embodiments, the method further includes broadcasting an indication of sub-channel PRB transmission support.

In accordance with another aspect of the present invention, there is provided a UE for use with a wireless communication network. The UE includes a wireless communication interface, a processor and a memory having machine executable instructions stored thereon. The machine executable instructions, when executed by the processor, configure the UE to generate plural sub-channel PRB transmissions for provision of a RACH procedure msg3 and transmit the plural sub-channel PRB transmissions.

In accordance with another aspect of the present invention, there is provided a base station of a wireless communication network. The base station includes a wireless communication interface, a processor and a memory having machine executable instructions stored thereon. The machine executable instructions, when executed by the processor, configure the base station to receive plural sub-channel PRB transmissions and combine the plural sub-channel PRB transmissions to determine RACH procedure msg3.

### BRIEF DESCRIPTION OF THE FIGURES

These and other features of the invention will become more apparent in the following detailed description in which reference is made to the appended drawings.

FIG. 1 illustrates a messaging sequence between a terminal and a base station according to the prior art LTE standard.

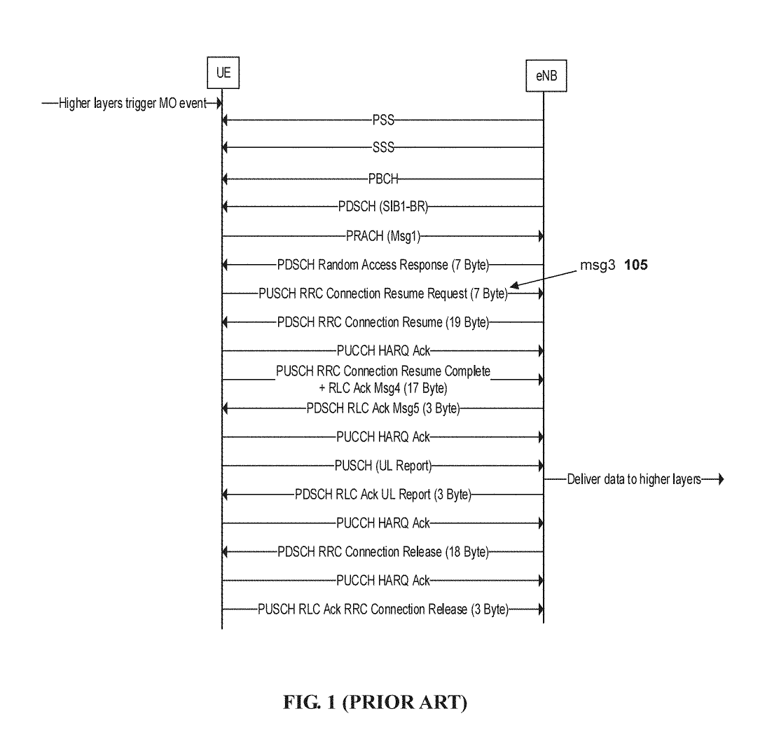

FIG. 2 illustrates a messaging sequence between a UE and a base station in accordance with embodiments of the present invention.

FIG. 3 illustrates repeated sub-channel PRB transmissions of msg3 in accordance with embodiments of the present invention.

FIG. 4 illustrates a method, at a UE, for performing sub-channel PRB uplink transmission, in accordance with embodiments of the present invention.

FIG. 5 illustrates a method, at a base station, for supporting sub-channel PRB uplink transmission, in accordance with embodiments of the present invention.

FIG. 6 illustrates a UE and a base station (e.g. eNB, gNB) of a wireless communication network, in accordance with an embodiment of the present invention.

### DETAILED DESCRIPTION OF THE INVENTION

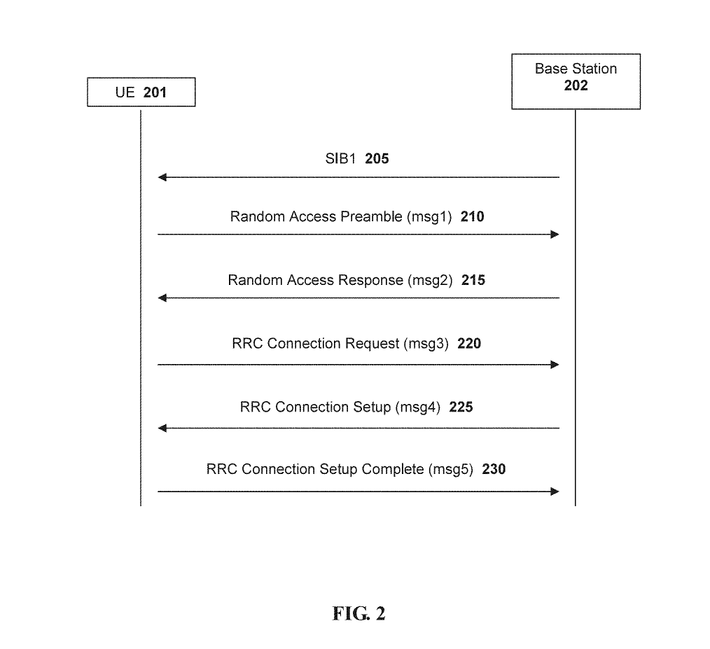

There are provided methods and apparatuses for supporting sub-channel PRB transmissions for the random access channel (RACH) procedure. FIG. 2 illustrates a messaging sequence between a UE and a base station in accordance with embodiments of the present invention. With reference to FIG. 2, there is illustrated the messages transferred between a base station 202 and a user equipment (UE) 201 during a RACH procedure. A random access preamble (message 1, msg1) 210 is transmitted by the UE 201 to the base station 202 and the base station responds with a random access response (message 2, msg2) 215. Message 3, msg3, 220 which is a radio resource control (RRC) connect request is subsequently transmitted by the UE to the base station. The base station responds with a RRC connection setup 225 (message 4, msg4), wherein the UE then responds with a RRC connection setup complete 230 (message 5, msg5).

According to embodiments of the instant application, the UE is configured to use sub-channel PRBs for the transmission of the msg3 to the base station. However, in order for the UE to use sub-channel PRBs for this transmission, the allocation of msg3 requires multiple msg3 repeats, for example 2 or more repeats, in order that each of the repeats of msg3 can carry a portion of the complete msg3. Upon receipt of the multiple msg3 repeats the base station can combine these repeats in order to determine the complete msg3 transmission.

In some embodiments, each repeat of the msg3 includes an equivalent sized portion of the complete msg3. In some embodiments, when 3 or more repeats of msg3 are provided at least two of the msg3 repeats have an equivalent size.

For example, there are a total of 12 RACH sub-channels available. As such, if there are four repeats of the msg3 being transmitted, the sub-channel PRB transmissions can be broken down such that each msg3 repeat includes a quarter of the information to be transmitted for the complete msg3 transmission. As would be readily understood, if there are three msg3 repeats, each of the msg3 repeats can include a third of the information being transmitted for the complete msg3 transmission.

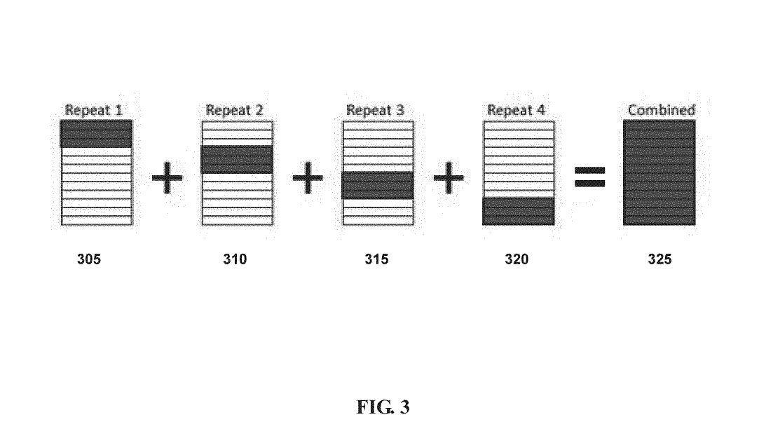

FIG. 3 illustrates repeated sub-channel PRB transmissions in accordance with embodiments of the present invention. This figure illustrates the above example, wherein there are four msg3 repeats, wherein a quarter of a complete msg3 transmission is transmitted during each repeat. Repeat 1 305 includes a first quarter of msg3 information within the first three sub-channels, repeat 2 310 includes a second quarter of msg3 information within subchannels 4 to 6, repeat 3 315 includes a third quarter of msg3 information within sub-channels 7 to 9 and the fourth repeat 320 includes the final quarter of the msg3 information in sub-channels 10 to 12. After receipt of these four repeats, the base station can combine the information received in the four repeats to evaluate the complete msg3 information 325.

According to embodiments, the base station can combine the plural msg3 repeats without specifically having prior information that the UE will be transmitting the msg3 in sub-channel PRBs.

According to some embodiments, the base station can be configured to detect if the UE is transmitting msg3 using sub-channel PRBs. For example, the base station can evaluate the energy profile on each of the repeats of the msg3. With reference to FIG. 3, the energy profile in the unused sub-channels, as shown in white, can thus allow the base station to determine that the UE is transmitting using sub-channel PRBs.

According to some embodiments, when the base station is configured to detect or determine if the UE is transmitting using sub-channel PRBs, the base station can transmit allocations of system resources in the msg4 transmission to the UE. In this manner, the UE will then have allocations of system resources for the subsequent transmission of msg5.

It is understood that essentially there is no spectral efficiency improvement in transmission of msg3 in sub-channel PRBs, since no other UE transmission can be multiplexed in the same repeat. However, using sub-channel PRB transmissions for msg3 can result in reduced UE power consumption due to a lower peak average to power ratio (PAPR), improved block error ratio (BLER), and increased power amplifier (PA) power.

According to some embodiments, a base station can be configured to broadcast an indication that the base station supports sub-channel PRB transmissions in msg3. In some embodiments, this indication can be broadcast by the base station in a system information block 1 (SIB1) or other system information block. With further reference to FIG. 2, SIB1 205 is transmitted by the base station prior to the RACH procedure being commenced with the transmission of msg1 210.

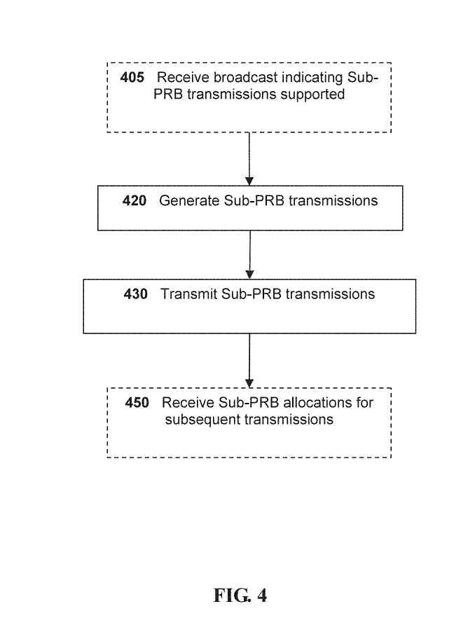

FIG. 4 illustrates a method, at a UE, for performing sub-channel PRB uplink transmission, in accordance with embodiments of the present invention. The method includes generating 420 plural sub-channel PRB transmissions for provision of a RACH procedure message 3 (msg3) and transmitting 430 the plural sub-channel PRB transmissions.

In some embodiments, the method further includes receiving 450 sub-channel PRB allocations for subsequent transmissions. In some embodiments, the method further includes receiving 405 a broadcast indicating sub-channel PRB transmissions are supported by a base station.

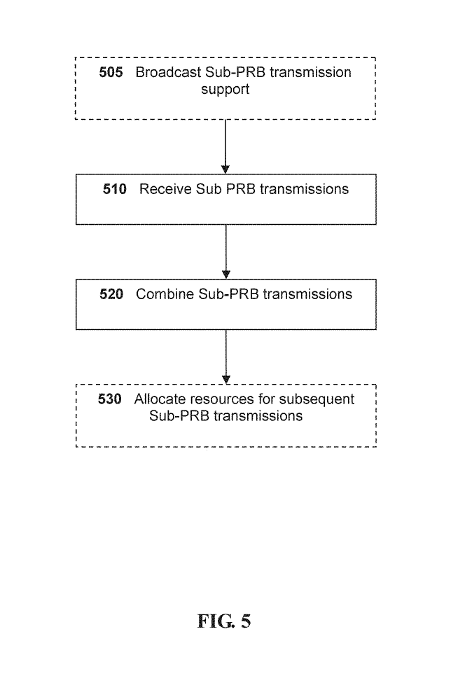

FIG. 5 illustrates a method, at a base station, for supporting sub-channel PRB uplink transmission, in accordance with embodiments of the present invention. The method includes receiving 510 plural sub-channel PRB transmissions and combining 520 the plural sub-channel PRB transmissions to determine RACH procedure message 3 (msg3).

In some embodiments, the method further includes transmitting 530 allocations for subsequent transmissions. In some embodiments, the method further includes broadcasting 505 indication of sub-channel PRB transmission support.

Various embodiments of the present invention may be implemented as a computer-implemented method, namely a method whose steps are implemented by computing devices such as by a combination of LTE network infrastructure devices such as eNBs or related infrastructure equipment as well as LTE wireless terminal UEs such as MTC UEs or other UEs. The method may thus be implemented in a distributed manner. The computing devices may implement the method by executing, by a processor (e.g. microprocessor), computer instructions stored in memory and operating various electronics associated with and controlled by the computing devices accordingly. Additionally or alternatively, some or all of the operations of the computing devices may be executed by electronics executing firmware instructions or dedicated electronics hardware configured to operate in a predetermined manner when presented with predetermined patterns of electronic inputs. In particular, a processor executing instructions stored in memory can be replaced, in some embodiments, with other electronic components (e.g. comprising FPGAs, ASICs, etc.) which perform the same function.

Various embodiments of the present invention may correspond to a system comprising a combination of LTE network infrastructure devices such as eNBs or related infrastructure equipment as well as LTE wireless terminal UEs such as MTC UEs or other UEs. The system may be described in terms of interacting modules, wherein each module corresponds to a selection of electronic components operating together to produce an effect. It should also be understood that embodiments of the present invention provide for a UE, a base station, or a system comprising same, which are configured to operate in accordance with one or a combination of the methods described herein.

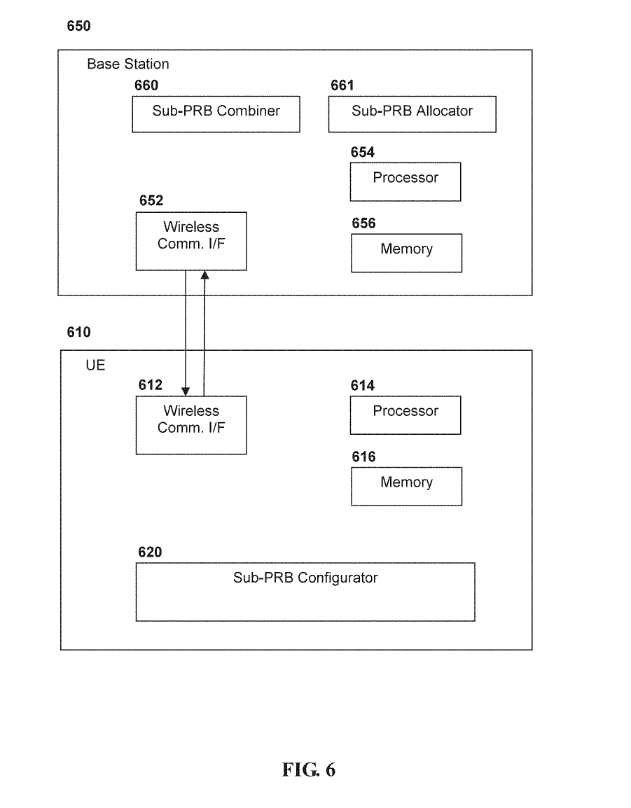

FIG. 6 illustrates a UE 610 and a base station 650 (eNB) of a wireless communication network, in accordance with an embodiment of the present invention. The UE 610 includes a wireless communication interface 612, a processor 614 and a memory 616. The memory 616 can include program instructions for execution by the processor 614 in order to cause the UE 610 to operate as described herein, for example to perform the methods described with respect to FIG. 4. The base station 650 includes a wireless communication interface 652, a processor 654 and a memory 656. The memory 656 can include program instructions for execution by the processor 654 in order to cause the base station 650 to operate as described herein, for example to perform the methods described with respect to FIG. 5. The UE 610 and the base station 650 communicate with each other via their respective wireless communication interfaces, for example using protocols compliant with the LTE standard.

In particular, the UE 610 is configured, for example via operation of a sub-PRB configurator 620 to generate sub-channel PRB transmissions and to transmit, using the wireless communication interface 612 and as part of a random access procedure, the sub-channel PRB transmissions.

According to some embodiments, the UE 610 is further configured to receive, using the wireless communication interface 612, a broadcast indicating support for sub-channel PRB transmission. According to some embodiments, the UE 610 is further configured to receive, using the wireless communication interface 612, sub-channel PRB allocations for subsequent transmissions. For example, the subsequent sub-channel PRB transmissions can be related to the transmission of msg5 of the RACH procedure.

The base station 650 is configured to receive, using the wireless communication interface, from a UE and as part of a random access procedure, plural sub-channel PRB transmissions, for example sub-channel PRB msg3 transmissions. The base station 650 is further configured for example via operation of a sub-PRB combiner 660, to combine the plural sub-channel PRB transmissions in order to determine the complete transmission from the UE. For example, the combination of multiple repeats of msg3 can be combined in order to determine the complete msg3 being transmitted by the UE.

In some embodiments, the base station 650 may further be configured, for example via operation of the sub-PRB allocator 661 and/or using the processor executing instructions held in the memory, to allocate system resources for subsequent sub-PRB transmissions by the UE. For example, the subsequent sub-channel PRB transmissions can be related to the transmission of msg5 of the RACH procedure. According to some embodiments, the base station 650 is further configured to transmit, using the wireless communication interface 652, a broadcast indicating support for sub-channel PRB transmissions.

It will be understood that the term “base station” or “base transceiver station (BTS)” refers to an evolved NodeB (eNB), New Radio (NR) or next generation NodeB (e.g., gNodeB or gNB), a radio access node, or another device in a wireless communication network infrastructure, such as an LTE infrastructure, which performs or directs at least some aspects of wireless communication with wireless communication devices. The term “terminal” or “UE” refers to a device, such as a mobile device, MTC device, or other device, which accesses the wireless communication network infrastructure via wireless communication with a base station.

It will be appreciated that, although specific embodiments of the technology have been described herein for purposes of illustration, various modifications may be made without departing from the scope of the technology. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Acts associated with the method described herein can be implemented as coded instructions in plural computer program products. For example, a first portion of the method may be performed using one computing device, and a second portion of the method may be performed using another computing device, server, or the like. In this case, each computer program product is a computer-readable medium upon which software code is recorded to execute appropriate portions of the method when a computer program product is loaded into memory and executed on the microprocessor of a computing device.

Further, each step of the method may be executed on any computing device, such as a personal computer, server, PDA, or the like and pursuant to one or more, or a part of one or more, program elements, modules or objects generated from any programming language, such as C++, Java, or the like. In addition, each step, or a file or object or the like implementing each said step, may be executed by special purpose hardware or a circuit module designed for that purpose.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

We claim:

1. A method for performing sub-channel physical resource block (PRB) uplink transmission by a User Equipment (UE) of a wireless communication network, the method comprising:
generating plural sub-channel PRB transmissions for provision of a random access channel (RACH) procedure message 3 (msg3); and
transmitting the plural sub-channel PRB transmissions.

2. The method of claim 1, further comprising receiving sub-channel PRB allocations for subsequent transmissions.

3. The method of claim 1, further comprising receiving a broadcast indicating sub-channel PRB transmissions are supported by a base station.

4. The method of claim 1, wherein each of the plural sub-channel PRB transmissions includes an equivalent sized portion of a complete RACH procedure msg3.

5. A method, in a base station of a wireless communication network, for supporting sub-channel physical resource block (PRB) uplink transmission by a user equipment (UE), the method comprising:
receiving plural sub-channel PRB transmissions; and
combining the plural sub-channel PRB transmissions to determine random access channel (RACH) procedure message 3 (msg3).

6. The method of claim 5, further comprising transmitting allocations for subsequent transmissions.

7. The method of claim 5, further comprising broadcasting an indication of sub-channel PRB transmission support.

8. The method of claim 5, wherein each of the plural sub-channel PRB transmissions includes an equivalent sized portion of a complete RACH procedure msg3.

9. The method of claim 5, further comprising detecting an energy profile in order to determine if the UE is transmitting a RACH procedure msg3 using sub-channel PRB uplink transmission.

10. A user equipment (UE) for use with a wireless communication network, the UE comprising a wireless communication interface, a processor and a memory having machine executable instructions stored thereon, the machine executable instructions, when executed by the processor, configure the UE to:
generate plural sub-channel physical resource block (PRB) transmissions for provision of a random access channel (RACH) procedure message 3 (msg3); and
transmit the plural sub-channel PRB transmissions.

11. The UE of claim 10, wherein the machine executable instructions, when executed by the processor, further configure the UE to receive sub-channel PRB allocations for subsequent transmissions.

12. The UE of claim 10, wherein the machine executable instructions, when executed by the processor, further configure the UE to receive a broadcast indicating sub-channel PRB transmissions are supported by a base station.

13. The UE of claim 10, wherein each of the plural sub-channel PRB transmissions includes an equivalent sized portion of a complete RACH procedure msg3.

14. A base station of a wireless communication network, the base station comprising a wireless communication interface, a processor and a memory having machine executable instructions stored thereon, the machine executable instructions, when executed by the processor, configure the base station to:
receive plural sub-channel physical resource block (PRB) transmissions; and
combine the plural sub-channel PRB transmissions to determine random access channel (RACH) procedure message 3 (msg3).

15. The base station of claim 14, wherein the machine executable instructions, when executed by the processor, further configure the base station to transmit allocations for subsequent transmissions.

16. The base station of claim 14, wherein the machine executable instructions, when executed by the processor, further configure the base station to broadcast an indication of sub-channel PRB transmission support.

17. The base station of claim 14, wherein each of the plural sub-channel PRB transmissions includes an equivalent sized portion of a complete RACH procedure msg3.

18. The base station of claim 14, wherein the machine executable instructions, when executed by the processor, further configure the base station to detect an energy profile in order to determine if the UE is transmitting a RACH procedure msg3 using sub-channel PRB uplink transmission.
